(19) United States
(12) Patent Application Publication
(10) Pub. No.: US 2024/0367583 A1
(43) Pub. Date: Nov. 7, 2024

(54) In-Vehicle Device, In-Vehicle System, and Method for Hands-Free Driving Assistance

(71) Applicant: Robert Bosch GmbH, Stuttgart (DE)

(72) Inventors: Lin Sun, Suzhou (CN); Xiaowen Yang, Suzhou (CN); Peng Ge, Suzhou (CN)

(21) Appl. No.: 18/687,232

(22) PCT Filed: Jun. 30, 2022
(86) PCT No.: PCT/EP2022/068095

§ 371 Date: Feb. 27, 2024

(30) Foreign Application Priority Data
Sep. 2, 2021 (CN) 202111024913.3

(51) Int. Cl. B60Q 9/00; B60T 7/12; B60T 8/171; B60T 8/172; B60T 17/22; B60W 60/00

(52) U.S. Cl. CPC B60Q 9/00; B60T 7/12; B60T 8/171; B60T 8/172; B60T 17/22; B60W 60/0053; B60W 60/0061; B60T 2201/03; B60T 2250/00; B60T 2250/02; B60W 2510/18; B60W 2510/20; B60W 2510/222; B60W 2710/18

(57) ABSTRACT

An in-vehicle device, an in-vehicle system, and a method for hands-free driving assistance are disclosed. The in-vehicle device includes: an obtaining module configured to obtain a hands-free assistance status signal from a hands-free driving assistance system of a vehicle and a steering assistance status signal from a steering system of the vehicle; an ascertainment module configured to ascertain, based on the hands-free assistance status signal, whether a hands-free driving assistance function of the vehicle is activated, and ascertain, based on the steering assistance status signal, whether a fault occurs in the steering system; a trigger module configured to trigger a brake jerk in a braking system of the vehicle if it is ascertained that the hands-free driving assistance function has been activated and that the fault occurs in the steering system; and a determination module configured to calculate, in real time and based on a mass of the vehicle, a duration that the brake jerk has lasted, and a rate of change in a longitudinal deceleration of the vehicle, a braking force for the brake jerk, for use in dynamic pressure build-up in the braking system during the brake jerk.

### TECHNICAL FIELD

The present application generally relates to vehicle functional safety in hands-free driving assistance, and in particular, to an in-vehicle device for hands-free driving assistance and an in-vehicle system for hands-free driving assistance, and further to a corresponding method for hands-free driving assistance and a corresponding machine-readable storage medium.

### BACKGROUND ART

During research and development of hands-free driving assistance, vehicle safety is the most concerned subject. For example, when a host vehicle is in a hands-free driving assistance process, once it is predicted the host vehicle may deviate from its traveling lane (current lane), a steering system is required to respond immediately to steer the host vehicle back to the vicinity of the center line of the current lane. However, if a fault occurs in the steering system of the vehicle at this time and thus leads to the loss of a steering assistance capability of the steering system, the host vehicle would soon deviate from the current lane, which may cause a severe collision.

In view of this, an existing solution is to use a redundant steering system in the vehicle. This allows a backup steering system to be enabled immediately to perform a steering assistance function, once a fault occurs in a primary steering system during the hands-free driving assistance process of the vehicle. However, the redundant steering system results in a significant increase in vehicle costs and is therefore not widely accepted.

Another existing solution is to sound an acoustic/optical alarm in the vehicle. Research shows that drivers usually take over the vehicle in a timely manner after receiving an acoustic/optical alarm. However, some of the drivers take over the vehicle with only one hand on a steering wheel. This would make it difficult for the drivers to manipulate the steering wheel to steer the vehicle, because it would be excessively heavy to manually turn the steering wheel when the steering assistance function of the steering system of the vehicle has been lost, and it is thus generally impossible to implement rapid steering of the vehicle with one-handed manipulation of the steering wheel. In this case, although the driver responds by taking over the vehicle, the vehicle will still deviate from the current lane.

Therefore, there is a need to study an effective security means to solve the above problem in the prior art.

### SUMMARY OF THE INVENTION

In this context, the present invention is intended to provide a solution for hands-free driving assistance, which is in line with the functional safety standard for road vehicles.

According to a first aspect of the present invention, an in-vehicle device for hands-free driving assistance is provided, the in-vehicle device including: an obtaining module configured to obtain a hands-free assistance status signal from a hands-free driving assistance system of a vehicle and a steering assistance status signal from a steering system of the vehicle; an ascertainment module configured to ascertain, based on the hands-free assistance status signal, whether a hands-free driving assistance function of the vehicle is activated, and ascertain, based on the steering assistance status signal, whether a fault occurs in the steering system; a trigger module configured to trigger a brake jerk in a braking system of the vehicle if it is ascertained that the hands-free driving assistance function has been activated and that the fault occurs in the steering system; and a determination module configured to calculate, in real time and based on a mass of the vehicle, a duration that the brake jerk has lasted, and a rate of change in a longitudinal deceleration of the vehicle, a braking force for the brake jerk, for use in dynamic pressure build-up in the braking system during the brake jerk.

According to a second aspect of the present invention, an in-vehicle system for hands-free driving assistance is provided, the in-vehicle system including: the in-vehicle device as described above, which is constructed to ascertain whether to trigger a brake jerk, and determine a dynamic braking force for the brake jerk upon ascertaining to trigger the brake jerk; and a human-machine interaction interface constructed to provide, in a vehicle, information for reminding a user to hold a steering wheel with both hands and take over the vehicle.

According to a third aspect of the present invention, a method for hands-free driving assistance is provided, which is optionally performed by the in-vehicle device as described above and/or the in-vehicle system as described above. The method includes: obtaining a hands-free assistance status signal from a hands-free driving assistance system of a vehicle and a steering assistance status signal from a steering system of the vehicle; ascertaining, based on the hands-free assistance status signal, whether a hands-free driving assistance function of the vehicle is activated, and ascertaining, based on the steering assistance status signal, whether a fault occurs in the steering system; triggering a brake jerk of the vehicle in a braking system of the vehicle if it is ascertained that the hands-free driving assistance function has been activated and that the fault occurs in the steering system; and calculating, in real time and based on a mass of the vehicle, a duration that the brake jerk has lasted, and a rate of change in a longitudinal deceleration of the vehicle, a braking force for the brake jerk, for use in dynamic pressure build-up in the braking system during the brake jerk.

According to a fourth aspect of the present invention, there is provided a machine-readable storage medium storing executable instructions that, when executed, cause one or more processors to perform the method as described above.

A summary of main aspects of the present invention is provided above, in order to facilitate a basic understanding of these aspects. The summary is neither intended to describe key or important elements of all aspects of the present invention, nor to limit the scope of any or all of the aspects of the present invention. The summary is intended to provide some implementations of these aspects in a simplified way, as a preface to the detailed description to be provided below.

### BRIEF DESCRIPTION OF THE DRAWINGS

FIG. 1 schematically shows an environment in which some implementations of the present invention may be implemented;

FIG. 2 is a schematic block diagram of an in-vehicle device according to an implementation of the present invention;

FIG. 3 is a flowchart of a hands-free driving assistance process according to an implementation of the present invention;

FIG. 4 shows a curve of a brake jerk according to an implementation of the present invention; and

FIG. 5 is a flowchart of a method for hands-free driving assistance according to an implementation of the present invention.

### DETAILED DESCRIPTION OF EMBODIMENTS

A hands-free driving assistance function of a vehicle should be in line with the functional safety requirements for road vehicles. For example, the hands-free driving assistance function should be in line with the Functional Safety standard for Automotive Electronic Systems ISO 26262.

For this reason, careful research is carried out on the controllability of a driver during hands-free driving assistance. A research result shows that the use of a warning means of a brake jerk can adequately make the driver aware of the urgency of a current situation and instinctively hold a steering wheel with both hands to take over a vehicle.

In addition, the warning means of the brake jerk may bring a certain degree of discomfort. However, a probability of losing lateral control during a life cycle of a vehicle is extremely low. For example, losing lateral control may occur at most once during the life cycle of the vehicle. Therefore, such a brake jerk, the most effective warning means, is acceptable.

Further, after research and demonstration, a probability that both loss of lateral control and an inability to perform a brake jerk occur in a same driving cycle during the life cycle of the vehicle is extremely low (acceptable from a safety perspective). For example, the probability that both the loss of lateral control and the inability to perform a brake jerk occur during the life cycle of the vehicle is about 10\hat{ }(−6). Therefore, the brake jerk means of the present invention is robust and feasible.

The present invention mainly relates to a safety solution for hands-free driving assistance, which can detect the loss of lateral control of the vehicle during hands-free driving assistance, trigger a brake jerk in a timely manner, and determine reasonable parameters for the brake jerk.

The technical solutions of the embodiments of the present invention are particularly applicable to a safety solution for hands-free driving assistance in scenarios consisting of highways, overpasses, national highways, and the like.

According to the technical solutions of the embodiments of the present invention, it is possible to achieve safety goals for road vehicles for the hands-free driving assistance function, that is, preventing the vehicle from deviating from a host lane throughout a hands-free driving assistance process, meeting the automotive safety integrity level (ASIL).

Specific embodiments of the present invention are described below in conjunction with the accompanying drawings.

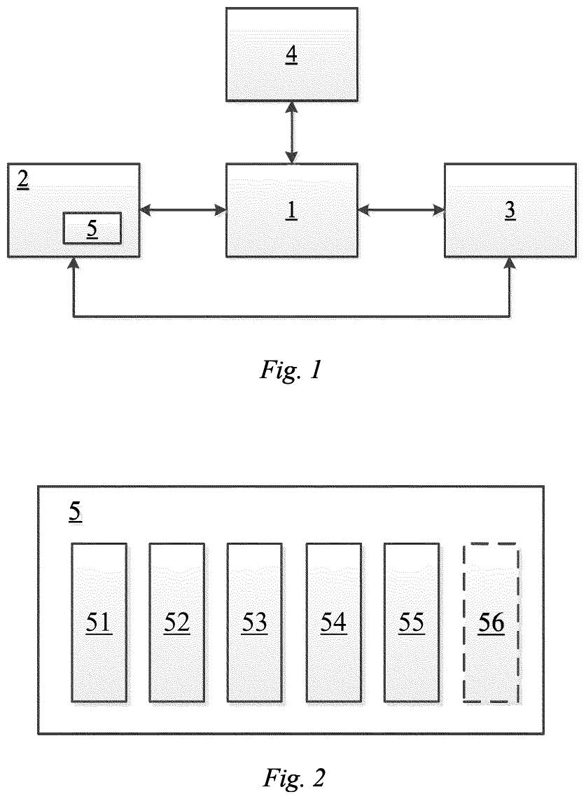

FIG. 1 schematically shows an environment in which some implementations of the present invention may be implemented, where the environment may be an in-vehicle application environment. In the environment shown in FIG. 1, a hands-free driving assistance system 1, a braking system 2, a steering system 3, a human-machine interaction interface 4, and an in-vehicle device 5, which are disposed in a vehicle, are mainly included.

The hands-free driving assistance system 1 receives a user input to activate a hands-free driving assistance function, and provides control logic for hands-free driving assistance. The control logic of the system may be set in a domain controller (not shown) of the vehicle.

The braking system 2 performs, upon receiving an instruction to trigger a brake jerk, the brake jerk based on brake-jerk parameters (for example, a duration of the brake jerk and a dynamic braking force during the duration) determined according to the embodiment of the present invention.

The steering system 3 provides lateral control for the vehicle. The steering system 3 communicates with the braking system 2 and the hands-free driving assistance system 1 (domain controller) in real time in the absence of a fault, such that they can know each other's statuses.

The human-machine interaction interface 4 provides, in the vehicle, an interaction between a user and a vehicle head unit. The human-machine interaction interface 4 can receive the user input and output information to the user. The human-machine interaction interface 4 can implement an information exchange between the user in the vehicle and the vehicle head unit by means of various human-machine interaction methods. The human-machine interaction methods may include one or more of screen touch, automatic speech recognition (ASR), action recognition (for example, gesture recognition), eyeball recognition, and brainwave recognition.

An aspect of the present invention provides an in-vehicle system for hands-free driving assistance, which may include the human-machine interaction interface (HMI) 4 and the in-vehicle device 5. The in-vehicle device 5 is constructed to determine whether to trigger a brake jerk, and determine a braking force for the brake jerk upon determining to trigger the brake jerk. The human-machine interaction interface 4 is constructed to provide, in a vehicle, information for reminding a user to hold a steering wheel with both hands and take over the vehicle.

The in-vehicle device 5 includes a hands-free driving assistance strategy according to the embodiment of the present invention. In FIG. 2, the in-vehicle device 5 according to an implementation of the present invention is shown, which mainly includes a detection module 51, an obtaining module 52, an ascertainment module 53, a trigger module 54, and a determination module 55. The detection module 51, the obtaining module 52, the ascertainment module 53, the trigger module 54, and the determination module 55 may be disposed in the braking system 2 of the vehicle. The working principles and processes of the modules are described in detail below.

In an embodiment, the in-vehicle device 5 may further include a reminder module 56. The reminder module 56 may be disposed in a domain controller of the vehicle. The reminder module 56 can communicate with the human-machine interaction interface 4, and output a reminder signal to the human-machine interaction interface 4 while the brake jerk is triggered in the vehicle, such that the human-machine interaction interface 4 provides information for reminding the user to hold the steering wheel with both hands and take over the vehicle.

It can be understood that the modules in the in-vehicle device 5 may be implemented by means of software or hardware or a combination of software and hardware, and the modules are named logically (functionally), rather than being defined in terms of their physical locations or specific implementations. For example, these modules may be disposed in a same chip or circuit, or may be disposed in different chips or circuits.

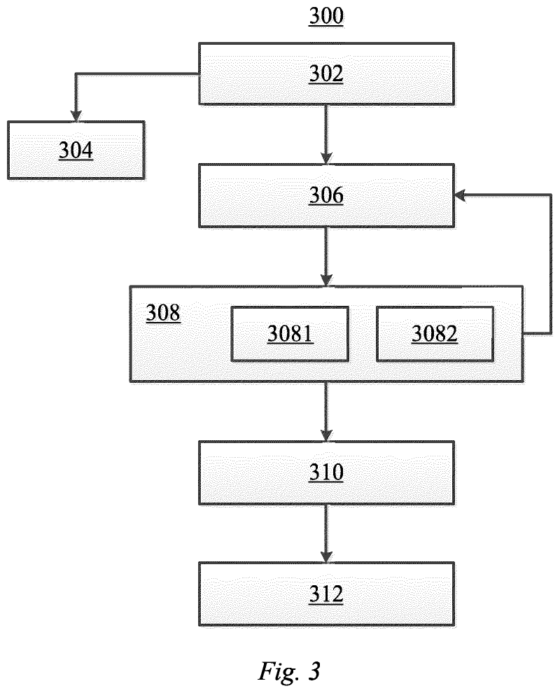

FIG. 3 shows a hands-free driving assistance process 300 according to an implementation of the present invention. The working principles and processes of an in-vehicle system and an in-vehicle device according to embodiments of the present invention are described below with reference to FIG. 3.

In block 302, the detection module 51 detects whether the braking system 2 of the vehicle is able to generate a brake jerk. When a detection result indicates that the braking system 2 is unable to generate the brake jerk, a control signal for disabling a hands-free driving assistance function is sent to a hands-free driving assistance system 1. In this case, the hands-free driving assistance function cannot be activated, and then, a driver should hold a steering wheel with both hands and drive the vehicle, and the hands-free driving assistance process 300 is exited (block 304). When the detection result indicates that the braking system 2 is able to generate the brake jerk, the hands-free driving assistance function is allowed to be activated, and the hands-free driving assistance process 300 is continued.

In an embodiment, at the beginning of each driving cycle of the vehicle, the detection module 51 conducts self-checking in the braking system 2. For example, the detection module 51 sends a control signal of trial operation to a motor of the braking system 2, to check whether the motor can operate properly. If the motor of the braking system can operate properly, it is considered that the braking system is able to generate the brake jerk. On the contrary, if the motor of the braking system is unable to operate, it is considered that the braking system is unable to generate the brake jerk.

In block 306, the obtaining module 52 obtains a hands-free assistance status signal from the hands-free driving assistance system 1 and a steering assistance status signal from the steering system 3. The hands-free assistance status signal can represent whether the hands-free driving assistance function is activated. The steering assistance status signal can represent a status of the steering system.

In block 308, the ascertainment module 53 ascertains whether conditions for triggering the brake jerk are met, that is, ascertaining whether the hands-free driving assistance function is activated and ascertaining whether a fault occurs in the steering system.

In block 3081, the ascertainment module 53 ascertains, based on the hands-free assistance status signal, whether the hands-free driving assistance function is activated. The hands-free assistance status signal may include a flag representing whether the hands-free driving assistance function is activated. The ascertainment module 53 identifies information of the flag to determine whether the hands-free driving assistance function is activated.

In block 3082, the ascertainment module 53 ascertains, based on the steering assistance status signal, whether the fault occurs in the steering system. The steering system 3 sends the steering assistance status signal to the braking system 2 at a predetermined time interval. The steering assistance status signal may include multiple fields, each of which represents one functional state of the steering system. For example, the multiple fields respectively correspond to a microcontroller state, a power state, and a communication state of the steering system. Upon detecting that a fault occurs in any one of the functional states of the steering system, it is considered that the fault occurs in the steering system.

In addition, there is a case in which the braking system is unable to receive the steering assistance status signal since a fault has occurred in communication between the steering system and the braking system. In this case, detection can be implemented through timeout ascertainment. For example, if the braking system has not received the steering assistance status signal over a predetermined duration, it is ascertained that the fault occurs in the steering system. The steering assistance status signal should be transmitted between the steering system and the braking system at a predetermined interval (namely, a predetermined duration), where the predetermined duration is preset in both the braking system and the steering system as a detection criterion. In other words, the braking system has an ascertainment criterion for ascertaining whether the steering assistance status signal times out.

It can be seen therefrom that when a fault occurs in at least one of the steering assistance function of the steering system and the communication between the steering system and the braking system, it is ascertained that the fault occurs in the steering system.

It can be understood that the present invention is intended to maximally detect faults and take safety measures, and is not intended to distinguish between types or causes of the faults. In other words, ascertainment logic for the steering system is designed to be able to detect a fault, not to identify a source or type of the fault.

In block 310, the trigger module 54 triggers the brake jerk if the ascertainment module 53 ascertains that the hands-free driving assistance function has been activated and that the fault occurs in the steering system.

The process returns to block 306 if the ascertainment module 53 ascertains that the hands-free driving assistance function has not been activated or that no fault occurs in the steering system.

In block 312, the determination module 55 determines a braking force for the brake jerk, such that the braking system implements the brake jerk using the determined braking force. The braking force for the brake jerk is dynamically changing throughout a brake jerk process, and is associated with a mass of the vehicle, a duration that the brake jerk has lasted, and a rate of change in a longitudinal deceleration of the vehicle, where the rate of change in the longitudinal deceleration of the vehicle can represent a degree of shaking (vibration) of the vehicle during a braking process.

The three parameters, i.e. the mass of the vehicle, the duration that the brake jerk has lasted, and the rate of change in the longitudinal deceleration of the vehicle, together have an impact on a user's perception of the brake jerk, that is, on whether the brake jerk triggered is sufficient to alert the user. In general, the user's perception should not be too weak, lest the brake jerk not alert the user sufficiently.

In an embodiment, the rate of change in the longitudinal deceleration of the vehicle and a total duration of the brake jerk are both variables throughout the brake jerk process. In this embodiment, lower limit values may be separately set for the rate of change in the longitudinal deceleration of the vehicle and the total duration of the brake jerk, to ensure that the two parameter values are not too small to achieve the above-described warning effect. Certainly, upper limit values may also be separately set for the two parameters, to prevent the two parameter values from being excessively large and thus cause damage to the vehicle or a driver. In this embodiment, within the respective upper and lower limits of the two parameters, the rate of change in the longitudinal deceleration of the vehicle and/or the total duration of the brake jerk may be adjusted, based on a specific application scenario, to a level that is sufficient to draw attention of the user to hold the steering wheel with both hands and take over the vehicle.

In another embodiment, the brake jerk has a predetermined duration. The predetermined duration may be obtained through experiments and/or model calculation. The determination module 55 calculates the braking force for the brake jerk based on the following formula:

$$F ( t ) = J ( k ) * m * t$$

where F(t) is a braking force required for the brake jerk at a moment t;
t is the duration that the brake jerk has lasted, a maximum value of t being the predetermined duration of the brake jerk;
J(k) is the rate of change in the longitudinal deceleration of the vehicle, which is associated with a suspension stiffness k of the vehicle; and
m is the mass of the vehicle.

In this embodiment, the total duration of the brake jerk is preset, and a dynamic braking force within the total duration is calculated in real time. The rate of change J(k) in the longitudinal deceleration of the vehicle may be determined by means of table look-up. For example, a correlation table including a correlation between the J(k) value and the suspension stiffness k of the vehicle is stored in the determination module 55. The determination module 55 inputs a current suspension stiffness of the vehicle into the correlation table and then finds a corresponding J(k) value.

It can be seen therefrom that a larger mass of the vehicle and/or a smaller suspension stiffness of the vehicle indicate/indicates a larger braking force for the brake jerk. On the contrary, a smaller mass of the vehicle and/or a larger suspension stiffness of the vehicle indicate/indicates a smaller braking force for the brake jerk. As such, matching braking forces for the brake jerk are provided for different vehicle parameters, thereby implementing vehicle safety more effectively.

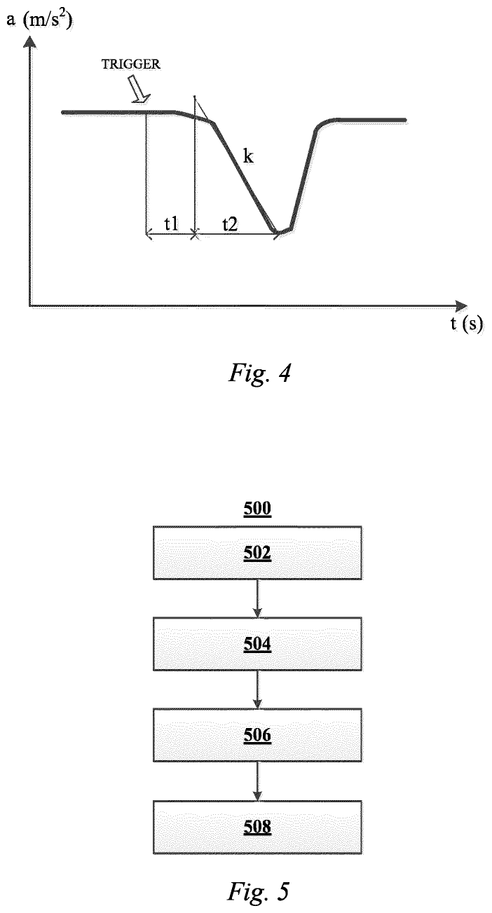

FIG. 4 shows a curve of a brake jerk according to an implementation of the present invention. Referring to FIG. 4, the abscissa represents time t, the ordinate represents a longitudinal deceleration a of a vehicle, and the curve represents a rate of change in the longitudinal deceleration a of the vehicle with respect to time t. The position shown by “TRIGGER” represents a trigger point for a brake jerk (namely, a moment at which a trigger signal for the brake jerk is generated). t1 represents a preparation duration for a braking system after receiving the trigger signal. For example, the braking system calculates a brake fluid volume and performs pre-filling within the preparation duration. t2 represents a total duration of the brake jerk. k represents a rate of change in the longitudinal deceleration of the vehicle during the brake jerk.

In an embodiment, the preparation duration t1 is 300 ms. The total duration t2 of the brake jerk is 350 ms. The rate of change k in the longitudinal deceleration of the vehicle is 17 m/s³.

In addition, while the brake jerk is triggered in the vehicle, information for reminding a driver to hold a steering wheel with both hands and take over the vehicle can be presented on a human-machine interaction interface. For example, the steering system 3 sends a fault signal to a domain controller when a fault occurs in the steering system, and the reminder module 56 disposed in the domain controller generates a reminder signal in response to the fault signal and then transmits the reminder signal to the human-machine interaction interface 4, so that the human-machine interaction interface 4 provides, in the vehicle, information for reminding the driver to hold the steering wheel with both hands and take over the vehicle.

It can be understood that when a fault occurs in the communication of the steering system and the fault signal can thus not be sent, the domain controller can, through timeout ascertainment logic similar to that described above, ascertain that a fault occurs in the steering system, to generate the reminder signal and send the reminder signal to the human-machine interaction interface.

FIG. 5 shows a method 500 for hands-free driving assistance according to an implementation of the present invention. The method may be performed by the in-vehicle device or in-vehicle system as described above, and the foregoing descriptions of the in-vehicle device and in-vehicle system are also applicable thereto.

Referring to FIG. 5, in step 502, a hands-free assistance status signal from a hands-free driving assistance system of a vehicle and a steering assistance status signal from a steering system of the vehicle are obtained.

In step 504, whether a hands-free driving assistance function of the vehicle is activated is ascertained based on the hands-free assistance status signal; and whether a fault occurs in the steering system is ascertained based on the steering assistance status signal.

In step 506, a brake jerk of the vehicle is triggered in a braking system of the vehicle if it is ascertained that the hands-free driving assistance function has been activated and that the fault occurs in the steering system.

In step 508, a braking force for the brake jerk is calculated in real time based on a mass of the vehicle, a duration that the brake jerk has lasted, and a rate of change in a longitudinal deceleration of the vehicle, for use in dynamic pressure build-up in the braking system during the brake jerk.

The present invention further provides a machine-readable storage medium storing executable instructions that, when executed, cause one or more processors to perform the above-described method 500 for hands-free driving assistance.

It can be understood that all the modules described above may be implemented in various ways. These modules may be implemented as hardware, software, or a combination thereof. In addition, any of these modules can be further divided into sub-modules or combined together in terms of function.

It can be understood that the processor may be implemented using electronic hardware, computer software, or any combination thereof. Whether these processors are implemented as hardware or software may depend on a specific application and overall design constraints imposed on the system. As an example, the processor, any part of the processor, or any combination of processors provided in the present invention can be implemented as a microprocessor, a microcontroller, a digital signal processor (DSP), a field programmable gate array (FPGA), a programmable logic device (PLD), a state machine, a gate logic, a discrete hardware circuit, and other suitable processing components configured to perform the various functions described in the present disclosure. Functions of the processors, any part of the processors, or any combination of the processors provided in the present invention can be implemented as software executed by a microprocessor, a microcontroller, a DSP, or other suitable platforms.

It can be understood that the software should be broadly regarded as representing instructions, instruction sets, codes, code segments, program codes, programs, subprograms, software modules, applications, software applications, software packages, routines, subroutines, objects, running threads, processes, functions, etc. The software can reside in a computer-readable medium. The computer-readable medium may include, for example, a memory, and the memory may be, for example, a magnetic storage device (such as a hard disk, a floppy disk, and a magnetic stripe), a compact disk, a smart card, a flash memory device, a random access memory (RAM), a read-only memory (ROM), a programmable ROM (PROM), an erasable PROM (EPROM), an electrically erasable PROM (EEPROM), a register or a removable disk. Although the memory is shown to be separate from the processor in the various aspects presented in the present invention, the memory (such as a cache or a register) may also be located inside the processor.

Although some implementations have been described above, these implementations are presented only as examples and are not intended to limit the scope of the present invention. The appended claims and equivalent replacements thereof are intended to cover all modifications, substitutions and changes made within the scope and subject matter of the present invention.

1. An in-vehicle device for hands-free driving assistance, comprising:
an obtaining module configured to obtain a hands-free assistance status signal from a hands-free driving assistance system of a vehicle and a steering assistance status signal from a steering system of the vehicle;
an ascertainment module configured to ascertain, based on the hands-free assistance status signal, whether a hands-free driving assistance function of the vehicle is activated, and ascertain, based on the steering assistance status signal, whether a fault occurs in the steering system;
a trigger module configured to trigger a brake jerk in a braking system of the vehicle if it is ascertained that the hands-free driving assistance function has been activated and that the fault occurs in the steering system; and
a determination module configured to calculate, in real time and based on a mass of the vehicle, a duration that the brake jerk has lasted, and a rate of change in a longitudinal deceleration of the vehicle, a braking force for the brake jerk, for use in dynamic pressure build-up in the braking system during the brake jerk.

2. The in-vehicle device according to claim 1, wherein the in-vehicle device further comprises a detection module which is configured to:
before the hands-free driving assistance function is activated, detect whether the braking system of the vehicle is able to generate the brake jerk;
when a detection result indicates that the braking system is unable to generate the brake jerk, send a control signal for disabling the hands-free driving assistance function to the hands-free driving assistance system of the vehicle to end this the hands-free driving assistance process; and
when the detection result indicates that the braking system is able to generate the brake jerk, allow the hands-free driving assistance function to be activated to continue this the hands-free driving assistance process.

3. The in-vehicle device according to claim 1, wherein:
the rate of change in the longitudinal deceleration of the vehicle and a total duration of the brake jerk are both variables, and they each have a predetermined lower limit value and upper limit value; and
the determination module is configured to adjust both the rate of change in the longitudinal deceleration of the vehicle and the total duration of the brake jerk to a level that is sufficient to draw attention of a user to hold a steering wheel with both hands and take over the vehicle.

4. The in-vehicle device according to claim 1, wherein the brake jerk has a predetermined duration, and the determination module is configured to calculate the braking force for the brake jerk based on the following formula:
F(t)=J(k)*m*t, where:
F(t) is a braking force required for the brake jerk at a moment t;
t is the duration that the brake jerk has lasted, a maximum value of t being the predetermined duration of the brake jerk;
J(k) is the rate of change in the longitudinal deceleration of the vehicle, which is associated with a suspension stiffness k of the vehicle; and
m is the mass of the vehicle.

5. The in-vehicle device according to claim 4, wherein:
the determination module has a correlation table including a correlation between the J(k) value and the suspension stiffness of the vehicle, and
the determination module is configured to look up the correlation table for a J(k) value corresponding to a current suspension stiffness of the vehicle.

6. The in-vehicle device according to claim 1, wherein upon ascertaining, based on the steering assistance status signal, that at least one of a steering assistance function of the steering system and communication between the steering system and the braking system is lost, the ascertainment module ascertains that the fault occurs in the steering system.

7. The in-vehicle device according to claim 2, wherein the in-vehicle device further comprises a reminder module which is configured to transmit a reminder signal to a human-machine interaction interface of the vehicle while the brake jerk is triggered to provide, in the vehicle, information for reminding a user to hold a steering wheel with both hands and take over the vehicle.

8. The in-vehicle device according to claim 7, wherein:
the detection module, the obtaining module, the ascertainment module, the trigger module, and the determination module are disposed in the braking system of the vehicle, and
the reminder module is disposed in a domain controller of the vehicle.

9. The in-vehicle system for hands-free driving assistance, comprising:
the in-vehicle device according to claim 1, which is configured to ascertain whether to trigger a brake jerk, and determine a dynamic braking force for the brake jerk upon ascertaining to trigger the brake jerk; and
a human-machine interaction interface configured to provide, in a vehicle, information for reminding a user to hold a steering wheel with both hands and take over the vehicle.

10. A method for hands-free driving assistance performed by the in-vehicle device according to claim 1, the method comprising:
obtaining a hands-free assistance status signal from a hands-free driving assistance system of a vehicle and a steering assistance status signal from a steering system of the vehicle;
ascertaining, based on the hands-free assistance status signal, whether a hands-free driving assistance function of the vehicle is activated,
ascertaining, based on the steering assistance status signal, whether a fault occurs in the steering system;
triggering a brake jerk of the vehicle in a braking system of the vehicle if it is ascertained that the hands-free driving assistance function has been activated and that the fault occurs in the steering system; and
calculating, in real time and based on a mass of the vehicle, a duration that the brake jerk has lasted, and a rate of change in a longitudinal deceleration of the vehicle, a braking force for the brake jerk, for use in dynamic pressure build-up in the braking system during the brake jerk.

11. A machine-readable storage medium storing executable instructions that, when executed, cause one or more processors to perform the method according to claim 10.
